(19) United States
(12) Patent Application Publication
(10) Pub. No.: US 2026/0263923 A1
(43) Pub. Date: Sep. 10, 2026

(54) INFORMATION PROCESSING DEVICE AND INFORMATION PROCESSING METHOD

(71) Applicant: SONY GROUP CORPORATION, TOKYO (JP)

(72) Inventor: TAKUYA IWAI, TOKYO (JP)

(21) Appl. No.: 19/167,817

(22) PCT Filed: Feb. 21, 2024
(86) PCT No.: PCT/JP2024/006267

§ 371 Date: Sep. 22, 2025

(30) Foreign Application Priority Data
Mar. 31, 2023 (JP) 2023-059360

(51) Int. Cl. A63F 13/355; A63F 13/837; G06T 7/73; G06T 15/20; H04L 67/131

(52) U.S. Cl. CPC A63F 13/355; G06T 7/73; G06T 15/20; H04L 67/131; A63F 13/837

(57) ABSTRACT

An information processing device is an information processing device that is communicably provided with a user terminal and executes a content for the user terminal, and includes a control unit. The control unit acquires an internal state of a content space from the user terminal.

Furthermore, the control unit extracts a target object included in a field of view of a user at present or in the near future on the basis of the internal state.

Furthermore, the control unit determines whether rendering the content space by a known object of the user terminal is possible on the basis of the target object. Furthermore, the control unit selects, in a case where it is determined that the rendering is possible, first rendering by the user terminal as a rendering method. Furthermore, the control unit selects, in a case where it is determined that the rendering is not possible, second rendering by the information processing device as the rendering method.

### FIELD

The present disclosure relates to an information processing device and an information processing method.

### BACKGROUND

In recent years, improvement in image processing capability and communication processing capability of various devices used by users such as smartphones, tablet terminals, personal computers (PCs), and game machines is remarkable. By using these devices as game terminals, the users can easily enjoy various game contents such as a first-person shooter (FPS) and an massively multiplayer online role-playing game (MMORPG), for example.

Note that there are two types of rendering methods of a game space in the game content: client-side rendering in which rendering is performed on a side of the game terminal; and server-side rendering in which rendering is performed on a side of a game server installed in a data center or the like.

### CITATION LIST

### Patent Literature

Patent Literature 1: JP 2020-151494 A

Patent Literature 2: JP 2015-531629 A

### SUMMARY

### Technical Problem

However, conventional technologies have room for further improvement in enabling execution of a content such as a game in which processing is more efficiently distributed between a client and a server.

Therefore, the present disclosure proposes an information processing device and an information processing method that enable execution of a content in which processing is more efficiently distributed between a client and a server.

### Solution to Problem

In order to solve the above problems, one aspect of an information processing device according to the present disclosure is an information processing device that is communicably provided with a user terminal and executes a content for the user terminal, and includes a control unit. The control unit acquires an internal state of a content space from the user terminal. The control unit extracts a target object included in a field of view of a user at present or in the near future on the basis of the internal state. The control unit determines whether rendering of the content space by a known object of the user terminal is possible on the basis of the target object. The control unit selects, in a case where it is determined that the rendering is possible, first rendering by the user terminal as a rendering method. The control unit selects, in a case where it is determined that the rendering is not possible, second rendering by the information processing device as the rendering method.

### BRIEF DESCRIPTION OF DRAWINGS

FIG. 1 is a diagram illustrating a configuration example of a game system according to an embodiment of the present disclosure.

FIG. 2 is a block diagram illustrating a configuration example of a game server according to the embodiment of the present disclosure.

FIG. 3 is a diagram illustrating an example of a determination condition when a rendering method is determined.

FIG. 4 is a block diagram illustrating a configuration example of a game terminal according to the embodiment of the present disclosure.

FIG. 5 is a processing sequence diagram executed by the game system according to the embodiment of the present disclosure.

FIG. 6 is a block diagram illustrating a configuration example of a game server according to a modification.

FIG. 7 is a processing sequence diagram executed by a game system including the game server according to the modification.

FIG. 8 is a hardware configuration diagram illustrating an example of a computer that implements a function of the game server.

### DESCRIPTION OF EMBODIMENTS

Hereinafter, embodiments of the present disclosure will be described in detail with reference to the drawings. Note that, in each of the following embodiments, the same parts are denoted by the same reference signs, and redundant description will be omitted.

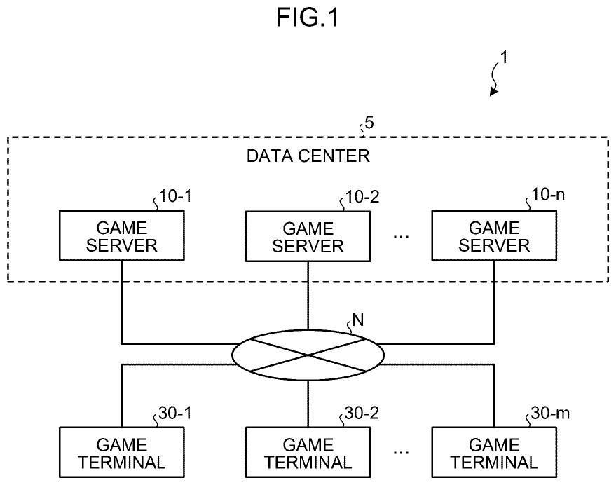

Furthermore, hereinafter, it is assumed that an information processing device according to an embodiment of the present disclosure (hereinafter, appropriately referred to as the “present embodiment”) is a game server 10 illustrated in FIG. 1 and subsequent drawings. Furthermore, it is assumed that an information processing system according to the present embodiment is a game system 1 (see FIG. 1 and subsequent drawings) including the game server 10 and a game terminal 30.

That is, a content provided to a user in the game system 1 is a game content, and the user is a player who plays a game. Note that, hereinafter, it is assumed that the game content is an FPS or a third-person shooter (TPS) in which the player moves in a game space from a viewpoint of a character itself operated by the player or a viewpoint of looking down on the character from a rear above a head of the character.

Furthermore, it is assumed that an information processing method according to the present embodiment is a selection method of a rendering method executed by the game server 10.

Furthermore, hereinafter, in a case where it is necessary to distinguish a plurality of the same components, numbering is performed in a format of “number” in the reference sign. For example, in a case where it is necessary to distinguish a plurality of the game servers 10, the plurality of game servers 10 is referred to as a game server 10-1, a game server 10-2, . . . . On the other hand, in a case where it is not necessary to distinguish the plurality of game servers 10, the plurality of game servers 10 is simply referred to as the game servers 10.

Furthermore, hereinafter, among rendering methods of the game space, client-side rendering in which rendering is performed on a side of the game terminal 30 is appropriately referred to as “first rendering”. On the other hand, server-side rendering in which rendering is performed on a side of the game server 10 is appropriately referred to as “second rendering”.

Furthermore, the present disclosure will be described according to the following item order.
1. Outline
1-1. Outline of Selection Method of Rendering Method According to Embodiment of Present Disclosure
1-2. Problem of Existing Technology
2. Configuration Example of Game System
3. Configuration Example of Game Server
4. Configuration Example of Game Terminal
5. Processing Sequence Executed by Game System
6. Modifications
6-1. Configuration Example of Game Server According to Modification
6-2. Case of Considering Game Scenario
6-3. Case of Causing First Rendering and Second Rendering to be Operated in Parallel
6-4. Content
6-5. Others
7. Hardware Configuration
8. Conclusion

### 1. Outline

### 1-1. Outline of Selection Method of Rendering Method According to Embodiment of Present Disclosure

First, an outline of the present embodiment will be described. In the selection method of the rendering method according to the present embodiment, the game server 10 that is communicably provided with the game terminal 30 and executes a game content for the game terminal 30 acquires an internal state of a game space from the game terminal 30. Furthermore, the game server 10 extracts a target object included in a field of view of a player at present or in the near future on the basis of the internal state. Furthermore, the game server 10 determines whether or not rendering of the game space by a known object of the game terminal 30 is possible on the basis of the target object. Furthermore, in a case where it is determined that the rendering is possible, the game server 10 selects the first rendering by the game terminal 30 as the rendering method. Furthermore, in a case where it is determined that the rendering is not possible, the game server 10 selects the second rendering by the game server 10 as the rendering method.

In a case where the selection method of the rendering method according to the present embodiment is used, the game terminal 30 makes, by the second rendering, a game playable without downloading a large amount of data from the game server 10, and also appropriately uses the first rendering in combination. With this configuration, it is possible to provide the game content in which processing is more efficiently distributed between the game terminal 30 and the game server 10. Furthermore, a game service provider can implement cost reduction for infrastructure (hereinafter, referred to as “infrastructure”) such as a data center 5 (see FIG. 1 and subsequent drawings) and a network that needs to be constructed and operated for providing the game content.

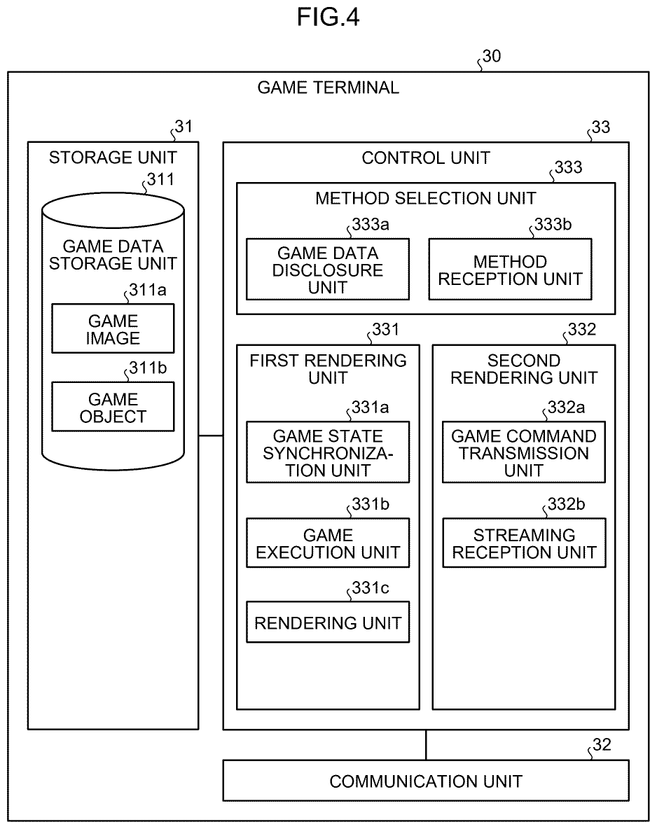

In the game system 1 according to the present embodiment, the game terminal 30 includes a communication unit 32, a first rendering unit 331, a second rendering unit 332, a method selection unit 333, a game data disclosure unit 333a, and a method reception unit 333b (see FIG. 4 and subsequent drawings) as processing units necessary for using the two types of rendering methods.

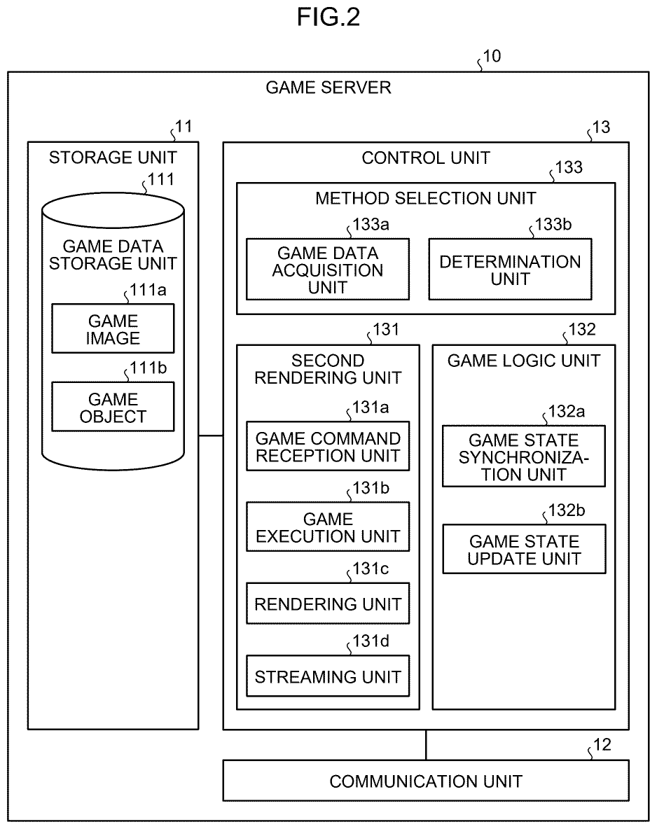

On the other hand, the game server 10 on a side of the data center 5 includes a communication unit 12, a second rendering unit 131, a game logic unit 132, a method selection unit 133, a game data acquisition unit 133a, and a determination unit 133b (see FIG. 2 and subsequent drawings).

In particular, the determination unit 133b acquires game state information (for example, positions, orientations, and the like of a player and a game object) from the game logic unit 132, and extracts a game object included in a field of view of the player at present or in the near future. Furthermore, the determination unit 133b determines whether the game terminal 30 can perform rendering with an object already stored, and determines the rendering method to be selected on the basis of a result of the determination. The game terminal 30 acquires the determined rendering method from the game server 10 via the method reception unit 333b.

Furthermore, in the game system 1, one player is connectable to the one game logic unit 132 from a plurality of clients (for example, the game server 10 on the side of the data center 5 or the game terminal 30 on a side of the player). With this configuration, seamless switching between the first rendering and the second rendering in which temporary interruption or termination of the game hardly occurs is implemented.

### 1-2. Problem of Existing Technology

Meanwhile, as described above, in the first rendering, the game terminal 30 performs the rendering. Furthermore, in the second rendering, the game server 10 performs the rendering, encodes a result of the rendering, and transmits the encoded result to the game terminal 30, and the game terminal 30 performs only decoding and display. These two types of the rendering methods each have opposing advantages and disadvantages.

For example, the first rendering does not need resources for the rendering, such as a graphical processing unit (GPU), in the data center 5. Furthermore, the first rendering does not need video transmission (hereinafter, appropriately referred to as “streaming”) to the side of the player. Therefore, there is an advantage that an investment cost related to the infrastructure such as the data center 5 or the network is reduced.

Note that resources of the game terminal 30 on the side of the player are limited, and as a result, it is difficult to render a dense and complex game space having an immersive feeling. Furthermore, it is necessary to hold a 3D object in the game space (for example, a character, a building, or the like in the game space) in the game terminal 30 in advance. Therefore, the game terminal 30 has a disadvantage that it is necessary to download a large amount of data before start of the game at the time of holding an event, for example, and the game cannot be started immediately.

On the other hand, since the second rendering performs the rendering using resources on the side of the data center 5, it is possible to render a denser and more complex game space than that of the first rendering. Furthermore, the second rendering is directly connected to a content delivery network (CDN) used when a large amount of data such as a 3D object is provided, for example, so that the second rendering has an advantage that a time needed for downloading a large amount of data can be reduced and the game can be started immediately.

Note that the second rendering is likely to be costly in terms of construction of the data center 5 for the second rendering, and the like. In particular, it is not realistic for the data center 5 to provide only the second rendering for the number of users expected in a massively multiplayer online game such as an MMORPG from a viewpoint of balance of revenue and expenditure.

In this manner, the first rendering and the second rendering have the opposing advantages and disadvantages. Therefore, a mechanism using both the methods in combination is needed.

For example, a technology disclosed in Patent Literature 1 uses both the second rendering and the first rendering in combination. Specifically, this technology simultaneously generates a visual content in addition to streaming in the second rendering, and transmits the visual content to a side of a player. A game terminal on the side of the player caches the visual content, and combines the visual content with an image to be displayed by streaming as necessary.

This technology enables adjustment of the image to be displayed by combining the streaming and the visual content according to a situation on the side of the player (such as a state of a network). However, this technology does not solve the compatibility of the advantages and disadvantages of the first rendering and the second rendering described above.

Furthermore, for example, a technology disclosed in Patent Literature 2 switches between the first rendering and the second rendering. Specifically, this technology performs switching from the first rendering to the second rendering or from the second rendering to the first rendering on the basis of a game-migration trigger event. The game-migration trigger event is, for example, a case where it is detected that necessary and sufficient software is not possessed (for example, an official version of software has not been purchased, software related to the next stage has not been downloaded, or the like, by the game terminal on the side of the player).

However, this technology does not have a mechanism for extracting a game object included in a field of view of a player in a game space at present or in the near future, and an amount of data downloaded by the player cannot be minimized. Therefore, this technology can perform the switching only in a coarser unit (for example, an official version or experimental version of software, a stage of a game, or the like) than that of the present embodiment. Therefore, in a case where this technology is used, it is considered that an amount of data per download becomes large, and a time until start of the game becomes longer than that of the present embodiment. Furthermore, in a case where this technology is used, it is considered that, in a game of an open world type in which there is no switching of a stage or the like of the game, the game-migration trigger event described above is hardly detected, and an effect to be obtained is reduced.

Hereinafter, a configuration example of the game system 1 according to the present embodiment configured to solve these problems will be described more specifically.

### 2. Configuration Example of Game System

FIG. 1 is a diagram illustrating a configuration example of the game system 1 according to the embodiment of the present disclosure. As illustrated in FIG. 1, the game system 1 includes the data center 5, one or more game terminals 30-1, 30-2, . . . 30-m (m is a natural number), and a network N. The data center 5 includes one or more game servers 10-1, 10-2,. 10-n (n is a natural number).

The network N is provided via, as an example, a cellular network, a wireless local area network (LAN) /wired LAN, or the like, and a configuration thereof including a network topology or the like is not particularly limited in the present embodiment. Therefore, hereinafter, configuration examples of the game server 10 and the game terminal 30 will be mainly described.

### 3. Configuration Example of Game Server

FIG. 2 is a block diagram illustrating the configuration example of the game server 10 according to the embodiment of the present disclosure. The data center 5 includes the one or more game servers 10 configured by hardware or software. FIG. 2 illustrates an example of a case where the game server 10 is configured by the hardware.

As illustrated in FIG. 2, the game server 10 includes a storage unit 11, the communication unit 12, and a control unit 13.

The storage unit 11 is implemented by, for example, a storage device such as a random access memory (RAM), a read only memory (ROM), a flash memory, or a hard disk drive (HDD).

In the example of FIG. 2, the storage unit 11 includes a game data storage unit 111. The game data storage unit 111 stores a game image 111a and a game object 111b. The game image 11la is a program image of a game content stored in a format that can be executed by a game execution unit 131b to be described later.

The game object 111b is an object group referred to by a rendering unit 131c to be described later. The game object 111 b is 3D data of other players, buildings, and the like that mainly appear in a game space, and includes at least modeling data related to shapes thereof, texture data related to appearances thereof, and bone data related to movements thereof. Note that, among objects included in the game object 111b, objects that need to be transmitted to the game terminal 30 on the basis of determination by the method selection unit 133 to be described later are transmitted in parallel with streaming.

Furthermore, although not illustrated, the storage unit 11 stores a program according to the present embodiment. The communication unit 12 communicates with the game terminal 30 via the network N. The communication unit 12 is implemented by a network adapter or the like.

The control unit 13 controls each unit of the game server 10. The control unit 13 is implemented by, for example, a central processing unit (CPU), a micro processing unit (MPU), a GPU, or the like executing the program according to the present embodiment stored in the storage unit 11 using a RAM as a work area. Furthermore, the control unit 13 can be implemented by, for example, an integrated circuit such as an application specific integrated circuit (ASIC) or a field programmable gate array (FPGA).

The control unit 13 includes the second rendering unit 131, the game logic unit 132, and the method selection unit 133. The control unit 13 implements or executes a function and an action of information processing to be described below using each of these processing units.

The second rendering unit 131 includes a series of processing units necessary for the second rendering. The second rendering unit 131 includes a game command reception unit 131a, the game execution unit 131b, the rendering unit 131c, and a streaming unit 131d.

The game logic unit 132 includes each of processing units necessary for updating an internal state of a game space. The game logic unit 132 includes a game state synchronization unit 132a and a game state update unit 132b.

The method selection unit 133 selects each method of the first rendering and the second rendering to be used for rendering. The method selection unit 133 includes the game data acquisition unit 133a and the determination unit 133b.

Note that an internal configuration of the control unit 13 is not limited to the configuration illustrated in FIG. 2, and may be another configuration as long as the information processing to be described below can be executed. Furthermore, in FIG. 2, the configuration of the game server 10 in which each processing unit is executed by one computer is exemplified. However, this is merely an example, and thus the game server 10 may have a configuration in which each processing unit is executed by a plurality of computers or a configuration in which each processing unit is executed transversally across a plurality of the data centers 5.

The game command reception unit 131a of the second rendering unit 131 receives a game command input (for example, an input using a button or the like implemented by software or hardware) from the game terminal 30.

The game execution unit 131b appropriately reads and executes the game image 111a and the game object 111b from the game data storage unit 111. Furthermore, the game execution unit 131b updates an internal state of a game space via the game state synchronization unit 132a to be described later on the basis of a game command received by the game command reception unit 131a. The internal state of the game space is, for example, a position, an orientation, and the like of each object of the game object 111b.

The rendering unit 131 c renders a 3D space on the basis of an internal state of a game space updated by the game execution unit 131b.

The streaming unit 131d encodes a result of rendering by the rendering unit 131c, and transmits the result to the game terminal 30.

Note that a protocol used by the game command reception unit 131a and the streaming unit 131d at the time of communication is not particularly limited, but implementation using a hypertext transfer protocol (HTTP), a transmission control protocol (TCP), a user datagram protocol (UDP), or the like is conceivable.

A method related to the encoding executed by the streaming unit 131d is similar, and can be implemented by using, for example, a general-purpose codec such as H.264 or H.265.

The game logic unit 132 performs processing related to an internal state of a game space. The game state synchronization unit 132a of the game logic unit 132 receives an input from the second rendering unit 131 or a game execution unit 331b of the first rendering unit 331 of the game terminal 30, and returns a processing result. The game state update unit 132b updates an internal state of a game space on the basis of an input from the second rendering unit 131 or the game execution unit 331b.

Note that means for the inputting or returning the processing result is not particularly limited, but implementation using an HTTP, a TCP, or a UDP is conceivable. In a payload related to the input, information related to coordinates and an orientation of an object corresponding to a player is stored. Furthermore, implementation in which, in a payload related to the processing result, information related to coordinates and orientations related to the player and other game objects (other players, buildings, and the like) is stored is conceivable as an example. These can also be implemented by using known technologies such as, for example, “Unreal Engine” which is a game engine developed by Epic Games, Inc. or “Unity” which is a game engine developed by Unity Technologies.

The method selection unit 133 selects whether to provide a game content to the game terminal 30 by the second rendering or by the first rendering. The game data acquisition unit 133a of the method selection unit 133 acquires a list of a game object 311b and a game image 311a stored in the game terminal 30 to be described later.

The determination unit 133b acquires a list of objects positioned around a player from the game state update unit 132b, and instructs execution of the first rendering in a case where the game terminal 30 stores sufficient objects. Furthermore, the determination unit 133b instructs execution of the second rendering in a case where the game terminal 30 does not sufficiently store the objects. Furthermore, the determination unit 133b also instructs downloading of an object that is insufficient at this time.

Whether or not the game terminal 30 stores the sufficient objects is determined on the basis of, for example, a position of the player, a traveling direction of the player, a width of a field of view of the player, and the like, using whether all objects to be included in the field of view of the player in the near future are held, or the like is used as a determination condition.

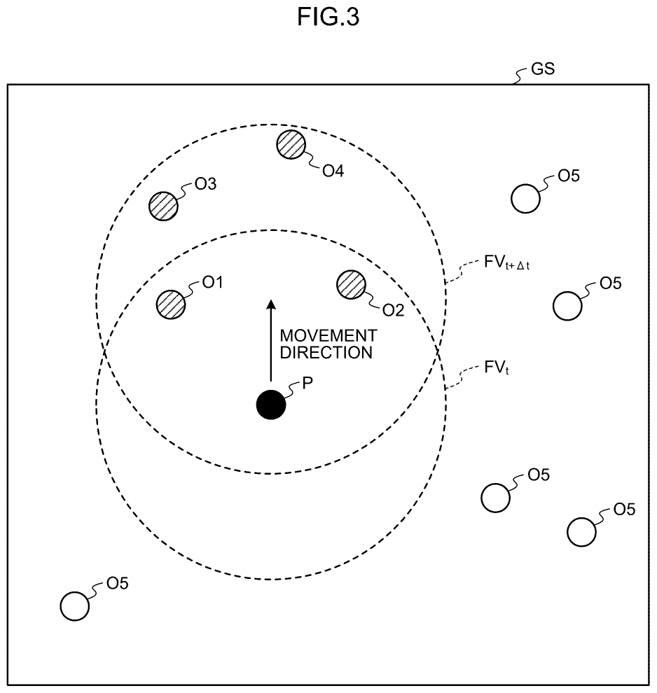

FIG. 3 is a diagram illustrating an example of the determination condition at the time of determining the rendering method. As illustrated in FIG. 3, a field of view FVₜ represents a present field of view of a player P with respect to a game space GS. A time point t corresponds to the present (current time point). It is assumed that the present field of view FVₜ includes objects O1 and O2.

The determination unit 133b performs determination to select the first rendering as the rendering method in a case where the game terminal 30 holds (knows) information related to all the objects O1 and O2 on the basis of the present field of view FVₜ. Furthermore, the determination unit 133b performs determination to select the second rendering as the rendering method in a case where the game terminal 30 does not hold the information related to all the objects O1 and O2.

Furthermore, the determination unit 133b can estimate a field of view FV_{t+Δt} in the near future corresponding to a time point t+Δt according to, for example, a movement direction. The near future can also be referred to as an elapsed time point of a predetermined time from the current time point. Then, in a case where the field of view FV_{t+Δt} further includes objects O3 and O4, the determination unit 133b may perform determination to select the first rendering as the rendering method when the game terminal 30 holds information related to all the objects O1, O2, O3, and O4.

Furthermore, in this case, the determination unit 133b performs determination to select the second rendering as the rendering method in a case where the game terminal 30 does not hold the information related to all the objects O1, O2, O3, and O4. Note that objects O5 refer to objects that are not included in any of the fields of view FVₜ and FV_{t+Δt}.

### 4. Configuration Example of Game Terminal

Next, FIG. 4 is a block diagram illustrating the configuration example of the game terminal 30 according to the embodiment of the present disclosure. As illustrated in FIG. 4, the game terminal 30 includes a storage unit 31, the communication unit 32, and a control unit 33. In addition to these, the game terminal 30 has a user interface implemented by hardware or software for inputting a command to a game, but is not illustrated here.

The storage unit 31 is implemented by, for example, a storage device such as a RAM, a ROM, a flash memory, or an HDD.

In the example of FIG. 4, the storage unit 31 includes a game data storage unit 311. The game data storage unit 311 stores the game image 311a and the game object 311b. The game image 311a is a program image of a game content stored in a format that can be executed by the game execution unit 331b to be described later.

The game object 311b is an object group referred to by a rendering unit 331c to be described later. The game object 311b is data similar to that of the game object 111b described above.

Furthermore, although not illustrated, the storage unit 31 stores a program according to the present embodiment. The communication unit 32 communicates with the game server 10 via the network N. The communication unit 32 is implemented by a network adapter or the like.

The control unit 33 controls each unit of the game terminal 30. The control unit 33 is implemented by, for example, a CPU, an MPU, a GPU, or the like executing the program according to the present embodiment stored in the storage unit 31 using a RAM as a work area. Furthermore, the control unit 33 can be implemented by, for example, an integrated circuit such as an ASIC or an FPGA.

The control unit 33 includes the first rendering unit 331, the second rendering unit 332, and the method selection unit 333. The control unit 33 implements or executes a function and an action of information processing to be described below using each of these processing units.

The first rendering unit 331 includes a series of processing units necessary for the first rendering. The first rendering unit 331 includes a game state synchronization unit 331a, the game execution unit 331b, and the rendering unit 331c.

The second rendering unit 332 includes a series of processing units necessary for the second rendering on the side of the game terminal 30. The second rendering unit 332 includes a game command transmission unit 332a and a streaming reception unit 332b.

The method selection unit 333 selects each method of the first rendering and the second rendering to be used for rendering. The method selection unit 333 includes the game data disclosure unit 333a and the method reception unit 333b.

Note that an internal configuration of the control unit 33 is not limited to the configuration illustrated in FIG. 4, and may be another configuration as long as the information processing to be described below can be executed.

The game state synchronization unit 331a of the first rendering unit 331 receives an input from the user interface described above (not illustrated), and causes the game execution unit 331b to update an internal state of a game space on the basis of the input.

The game execution unit 331b appropriately reads and executes the game image 311a and the game object 311b from the game data storage unit 311. A series of processing executed by the game execution unit 331b is different for each game, and they are stored as the game image 311a in the game data storage unit 311. Furthermore, the game execution unit 331b updates an internal state of a game space via the game state synchronization unit 331a.

The rendering unit 331c renders a 3D space on the basis of an internal state of a game space updated by the game execution unit 331b. The rendering unit 331c performs rendering using 3D data stored as the game object 311 b in the game data storage unit 311.

The game command transmission unit 332a of the second rendering unit 332 transmits an input from the user interface described above (not illustrated) to the game command reception unit 131a of the game server 10. The streaming reception unit 332b receives and decodes streaming encoded and transmitted after the second rendering in the game server 10.

Note that a protocol used by the game command transmission unit 332a and the streaming reception unit 332b is not particularly limited, but for example, implementation using an HTTP, a TCP, or a UDP is conceivable.

Furthermore, a method related to the decoding executed by the streaming reception unit 332b is similar, and can be implemented by using, for example, a general-purpose codec such as H.264 or H.265.

The game data disclosure unit 333a of the method selection unit 333 transmits a list of objects included in the game object 311b stored in the game data storage unit 311 to the game data acquisition unit 133a of the game server 10.

The method reception unit 333b receives the rendering method determined by the determination unit 133b of the game server 10. Note that a protocol used when the game data disclosure unit 333a discloses the object stored in the game data storage unit 311 is not particularly limited, and implementation using an HTTP, a TCP, or a UDP is conceivable.

Note that a payload at this time needs to include at least a game title, an identifier of a player in a game, and a list of identifiers of the respective objects included in the game object 311b stored in the game data storage unit 311. Both the title and the identifier are expressed by text or binary, for example.

Furthermore, a protocol used by the method reception unit 333b is also not particularly limited, and implementation using an HTTP, a TCP, or a UDP is conceivable. Note that a payload at this time includes at least a flag of the rendering method (for example, a truth value of which one of the first rendering and the second rendering is indicated). Furthermore, in a case where the second rendering is selected, an IP address and a port number of the game server 10 are included. Alternatively, in a case where the first rendering is selected, an IP address and a port number related to the game logic unit 132 are included. As a matter of course, another piece of information may be further included according to an implementation state of each game, or the like.

### 5. Processing Sequence Executed by Game System

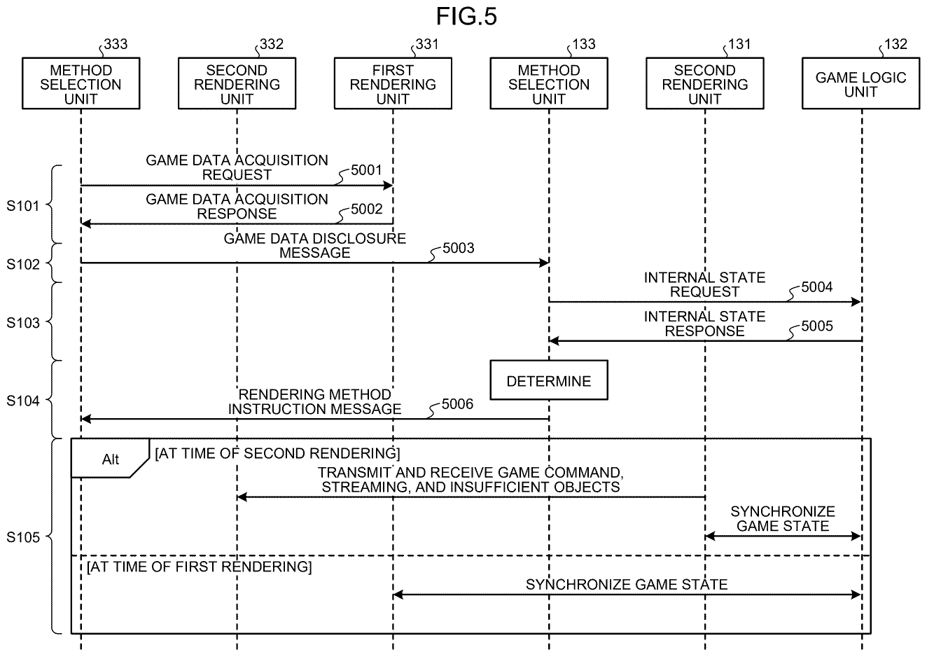

Next, a processing sequence executed by the game system 1 configured as described above will be described with reference to FIG. 5. FIG. 5 is a processing sequence diagram executed by the game system 1 according to the embodiment of the present disclosure.

As illustrated in FIG. 5, in the game system 1, in step S101, the method selection unit 333 of the game terminal 30 transmits, to the first rendering unit 331 of the game terminal 30, a game data acquisition request 5001 for stored game data. In response to the game data acquisition request 5001, the first rendering unit 331 transmits, to the method selection unit 333, a game data acquisition response 5002 including a list of each object included in the game object 311b (step S101).

Then, in step S102, the method selection unit 333 transmits, to the method selection unit 133 of the game server 10, a game data disclosure message 5003 including a game title, an identifier of a player, and the list of each object.

Subsequently, in step S103, the method selection unit 133 of the game server 10 transmits an internal state request 5004 to the game logic unit 132 on the basis of the game title included in the game data disclosure message 5003. The internal state request 5004 includes the identifier of the player, and the like. In response to the internal state request 5004, the game logic unit 132 transmits an internal state response 5005 to the method selection unit 133. The internal state response 5005 includes a movement direction of the player, each object around the player, and a position and an orientation of the object.

Then, in step S104, the method selection unit 133 of the game server 10 compares the internal state response 5005 with the game data disclosure message 5003. Then, the method selection unit 133 determines whether the game terminal 30 stores the game object 311b sufficient for the first rendering, and transmits, to the method selection unit 333 of the game terminal 30, a result of the determination as a rendering method instruction message 5006. The rendering method instruction message 5006 includes, in addition to the selected rendering method, an IP address and a port number of the second rendering unit 131 or the game logic unit 132, a list of insufficient objects, and the like according to the selected method.

Then, in a case where the second rendering is instructed, in step S105, the second rendering unit 332 of the game terminal 30 is connected to the second rendering unit 131 of the game server 10 using the IP address and the port number included in the rendering method instruction message 5006, and transmits and receives a game command, streaming, and the insufficient objects. Moreover, the second rendering unit 131 of the game server 10 is connected to the game logic unit 132 via the game execution unit 131b, and updates an internal state of a game space.

On the other hand, in a case where the first rendering is instructed, the first rendering unit 331 of the game terminal 30 is connected to the game logic unit 132 of the game server 10 using the IP address and the port number included in the rendering method instruction message 5006, and updates the internal state of the game space.

As described above, in the selection method of the rendering method according to the present embodiment, an internal state (for example, positions of a player and an object, and the like) of a game space is acquired, and an object included in a field of view of the player at present or in the near future is extracted. Then, in the selection method of the rendering method according to the present embodiment, it is determined whether the game terminal 30 can perform rendering with an object already stored, and the rendering method to be selected is determined on the basis of a result of the determination.

With this configuration, according to the selection method of the rendering method according to the present embodiment, it is possible to select the first rendering or the second rendering more finely than in the existing technology. Furthermore, as a result, according to the selection method of the rendering method according to the present embodiment, it is also possible to suppress an influence on bodily sensation of the player such as an activation time of a game while suppressing use of the expensive second rendering.

### 6. Modifications

Meanwhile, the embodiment of the present disclosure described above can include several modifications.

### 6-1. Configuration Example of Game Server According to Modification

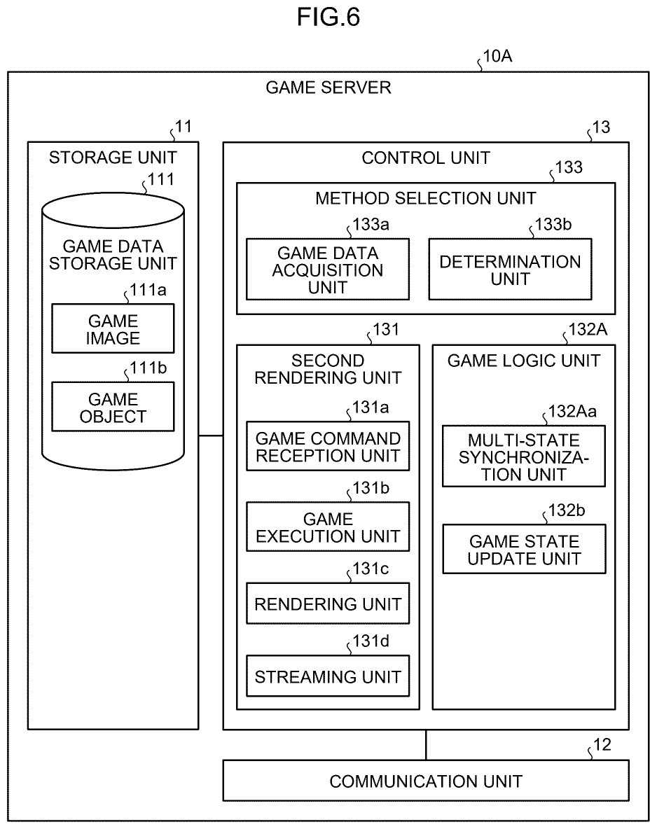

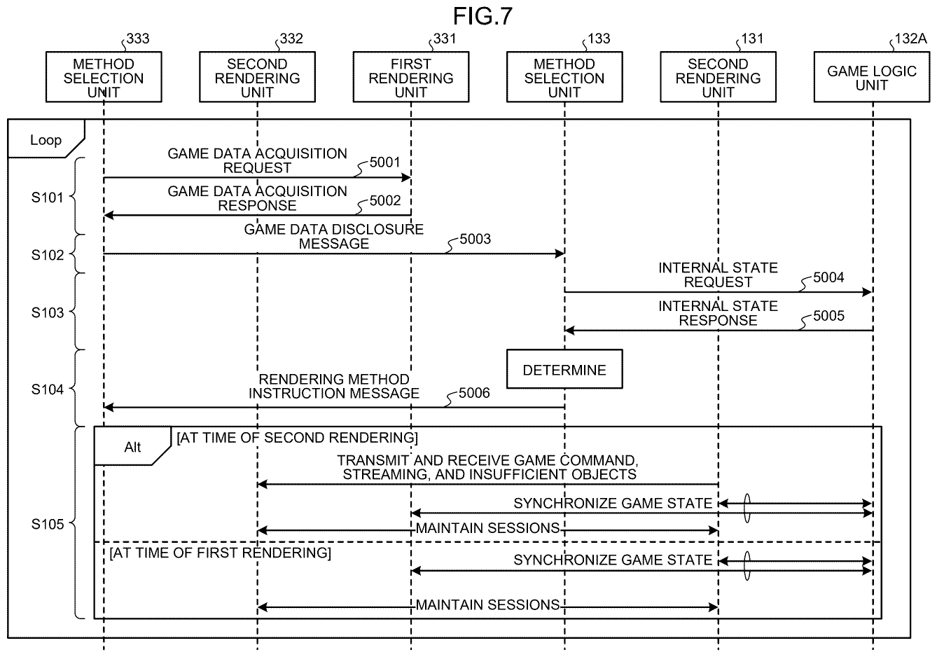

For example, switching between the first rendering and the second rendering is preferably performed more seamlessly. A configuration example of a game server 10A according to a modification for implementing this will be described with reference to FIGS. 6 and 7. FIG. 6 is a block diagram illustrating the configuration example of the game server 10A according to the modification. Furthermore, FIG. 7 is a processing sequence diagram executed by the game system 1 including the game server 10A according to the modification.

Note that, since FIG. 6 corresponds to FIG. 2, differences from FIG. 2 will be mainly described in the description using FIG. 6. Similarly, since FIG. 7 corresponds to FIG. 5, differences from FIG. 5 will be mainly described in the description using FIG. 7.

As illustrated in FIG. 6, the game server 10A is different from that of FIG. 2 in including a game logic unit 132A instead of the game logic unit 132 in FIG. 2. The game logic unit 132A is different from that of FIG. 2 in including a multi-state synchronization unit 132Aa instead of the game state synchronization unit 132a of FIG. 2.

The game logic unit 132a performs processing related to an internal state of a game space. The multi-state synchronization unit 132Aa of the game logic unit 132A receives an input from the second rendering unit 131 or the game execution unit 331b of the game terminal 30, and returns a processing result. The game state update unit 132b updates an internal state of a game space on the basis of an input from the second rendering unit 131 or the game execution unit 331b.

The multi-state synchronization unit 132Aa can be simultaneously connected to one or more game execution units 131b or game execution units 331b. Therefore, the multi-state synchronization unit 132Aa manages, in addition to an identifier of a player, end points (for example, IP addresses or port numbers) of the game execution unit 131b and the game execution unit 331b. Then, the multi-state synchronization unit 132Aa can simultaneously update an internal state of a game space by the game state update unit 132b on the basis of inputs from the plurality of game execution units 131b and game execution units 331b, and simultaneously return a result of the update to the plurality of game execution units 131b and game execution units 331b.

FIG. 7 illustrates a processing sequence diagram executed by the game system 1 including the game server 10A. FIG. 7 is different from FIG. 5 in that steps S101 to S105 are repeatedly executed. Furthermore, FIG. 7 is further different from FIG. 5 in that synchronization of a game state notifying an internal state of a game space from the game logic unit 132A is performed with a plurality of the second rendering units 131 or first rendering units 331. Furthermore, FIG. 7 is further different from FIG. 5 in that sessions of the second rendering unit 131 (the game command reception unit 131a and the streaming unit 131d) and the second rendering unit 332 (the game command transmission unit 332a and the streaming reception unit 332b) are maintained regardless of the time of the second rendering/the time of the first rendering.

In this manner, by enabling the same player to be connected from a plurality of clients (the second rendering unit 131 and the first rendering unit 331) to the game logic unit 132A, it is possible to more seamlessly switch between the first rendering and the second rendering in which temporary interruption or termination of a game hardly occurs.

### 6-2. Case of Considering Game Scenario

Furthermore, in the description with reference to FIG. 3, the determination unit 133b determines the rendering method to be selected on the basis of the present field of view FVₜ of the player P and the field of view FV_{t+Δt} in the near future corresponding to the time point t+Δt according to progress of the game. However, a game scenario may be considered in estimating the field of view FV_{t+Δt}.

This is because there is a case where a new object suddenly appears in the field of view FV_{t+Δt} due to occurrence of a predetermined event in the progress of the game although the object does not exist in the game space GS. In this case, the determination unit 133b estimates all objects that can appear in the field of view FV_{t+Δt} by analyzing the game scenario included in game data. Then, the determination unit 133b performs determination to select the first rendering as the rendering method in a case where the game terminal 30 holds information related to all the objects that can appear.

### 6-3. Case of Causing First Rendering and Second Rendering to be Operated in Parallel

Furthermore, in the present embodiment, the first rendering and the second rendering are switched, but control may be performed such that the first rendering and the second rendering are operated in parallel and the rendering is partially complemented.

For example, in a case where the determination unit 133b does not consider the game scenario described above and in a case where the new object described above suddenly appears while the game is in progress in rendering by the first rendering, control may be performed such that the new object is temporarily complemented by rendering by the second rendering.

### 6-4. Content

Furthermore, in the present embodiment, it is assumed that the content is the game content, but the content may be other than the game content. The content may be, for example, an XR (cross reality) content or the like in which a user is movable in a content space from a viewpoint of the user.

### 6-5. Others

Among the respective types of processing described in the embodiments of the present disclosure described above, all or a part of the types of the processing described as being performed automatically can be performed manually, or all or a part of the types of the processing described as being performed manually can be performed automatically by a known method. In addition, the processing procedure, specific name, and information including various types of data and parameters indicated above and in the drawings can be optionally changed unless otherwise specified. For example, various types of the information illustrated in each drawing are not limited to the illustrated information.

Furthermore, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in an optional unit according to various loads, use conditions, and the like.

Furthermore, the embodiments of the present disclosure described above can be appropriately combined in an area in which processing contents do not contradict each other. Furthermore, order of each step illustrated in the sequence diagram or the flowchart of the present embodiments can be appropriately changed.

### 7. Hardware Configuration

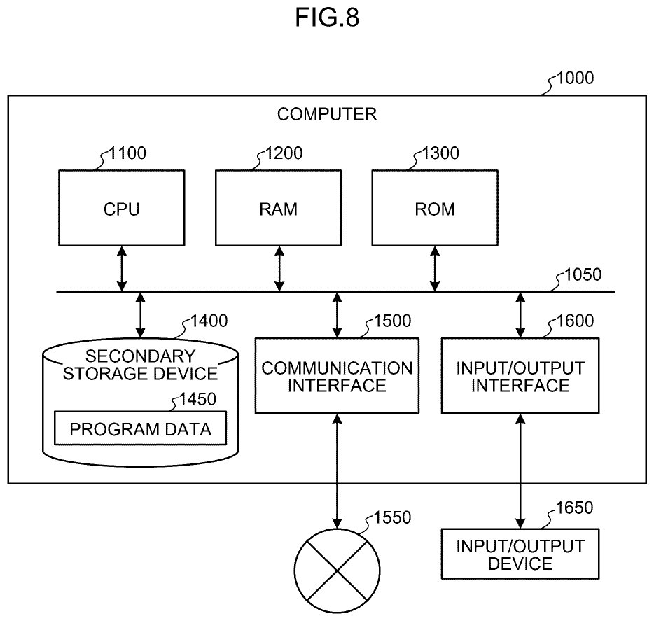

Furthermore, the game servers 10 and 10A and the game terminal 30 according to the embodiments of the present disclosure described above are implemented by, for example, a computer 1000 having a configuration as illustrated in FIG. 8. The game servers 10 and 10A will be described as an example. FIG. 8 is a hardware configuration diagram illustrating an example of the computer 1000 that implements functions of the game servers 10 and 10A. The computer 1000 includes a CPU 1100, a RAM 1200, a ROM 1300, a secondary storage device 1400, a communication interface 1500, and an input/output interface 1600. Each unit of the computer 1000 is connected by a bus 1050.

The CPU 1100 operates on the basis of programs stored in the ROM 1300 or the secondary storage device 1400, and controls each unit. For example, the CPU 1100 develops the programs stored in the ROM 1300 or the secondary storage device 1400 in the RAM 1200, and executes processing corresponding to the various programs.

The ROM 1300 stores a boot program such as a basic input output system (BIOS) executed by the CPU 1100 when the computer 1000 is activated, a program depending on hardware of the computer 1000, and the like.

The secondary storage device 1400 is a computer-readable recording medium that non-transiently records a program executed by the CPU 1100, data used by such a program, and the like. Specifically, the secondary storage device 1400 is a recording medium that records a program according to the present embodiment.

The communication interface 1500 is an interface for the computer 1000 to connect to an external network 1550. For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. Furthermore, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the game server 10 or 10A, the CPU 1100 of the computer 1000 implements the function of the control unit 13 by executing a program loaded on the RAM 1200. Furthermore, the secondary storage device 1400 stores a program according to the present disclosure, a program according to the modification, and data in the storage unit 11. Note that the CPU 1100 reads program data 1450 from the secondary storage device 1400 and executes the program data 1450, but as another example, these programs may be acquired from another device via the external network 1550.

### 8. Conclusion

As described above, according to an embodiment of the present disclosure, the game server 10 (corresponding to an example of an “information processing device”) is an information processing device that is communicably provided with the game terminal 30 (corresponding to an example of a “user terminal”) and executes a game content (corresponding to an example of a “content”) for the game terminal 30, and includes the control unit 13. The control unit 13 acquires an internal state of a game space (corresponding to an example of a “content space”) from the game terminal 30. Furthermore, the control unit 13 extracts a target object included in a field of view of a player (corresponding to an example of a “user”) at present or in the near future on the basis of the internal state. Furthermore, the control unit 13 determines whether or not rendering of the game space by a known object of the game terminal 30 is possible on the basis of the target object. Furthermore, in a case where it is determined that the rendering is possible, the control unit 13 selects the first rendering by the game terminal 30 as the rendering method. Furthermore, in a case where it is determined that the rendering is not possible, the control unit 13 selects the second rendering by the game server 10 as the rendering method. With this configuration, it is possible to execute a content in which processing is more efficiently distributed between a client and a server.

Although the embodiments of the present disclosure have been described above, the technical scope of the present disclosure is not limited to the embodiments described above as they are, and various modifications can be made without departing from the gist of the present disclosure. Furthermore, components of different embodiments and modifications may be appropriately combined.

Furthermore, the effects of the embodiments described in the present specification are merely examples and are not limited, and other effects may be provided.

Note that the present technology can also have the following configurations.
(1)

An information processing device that is communicably provided with a user terminal and executes a content for the user terminal, the information processing device comprising
a control unit that
acquires an internal state of a content space from the user terminal,
extracts a target object included in a field of view of a user at present or in the near future on the basis of the internal state,
determines whether rendering of the content space by a known object of the user terminal is possible on the basis of the target object,
selects, in a case where it is determined that the rendering is possible, first rendering by the user terminal as a rendering method, and
selects, in a case where it is determined that the rendering is not possible, second rendering by the information processing device as the rendering method.
(2)

The information processing device according to (1), wherein
the control unit
executes the content that enables movement in the content space at least from a viewpoint of the user,
acquires a list of known objects of the user terminal from the user terminal,
selects the first rendering in a case where it is determined that all the target objects are known by the user terminal on the basis of the list, and
selects the second rendering in a case where it is determined that all the target objects are not known by the user terminal on the basis of the list.
(3)

The information processing device according to (2), wherein
the internal state
includes at least any one of a position of the user, an orientation of the user, a position of an object, and an orientation of an object in the content space, and
the control unit
estimates the target object included in the field of view of the user in the near future on the basis of the internal state.
(4)

The information processing device according to (2) or (3), wherein
the control unit
estimates the target object included the field of view of the user in the near future on the basis of a scenario of the content.
(5)

The information processing device according to any one of (1) to (4), wherein
the control unit
acquires a command input by the user to the user terminal,
updates the internal state on the basis of the command, and
synchronizes the updated internal state with the user terminal.
(6)

The information processing device according to (5), wherein
the control unit
is simultaneously connectable to one or more of the user terminals,
updates the internal state of each of the user terminals on the basis of an input from each of the user terminals, and
synchronizes the updated internal state with each of the user terminals.
(7)

The information processing device according to (6), wherein
the control unit
is communicably provided with the user terminal, and is simultaneously connectable to one or more other information processing devices that execute the content for the user terminal,
updates the internal state of each of the other information processing devices on the basis of an input from each of the one or more other information processing devices, and
synchronizes the updated internal state with each of the other information processing devices.
(8)

The information processing device according to (7), wherein
the control unit
maintains sessions between one or more of the user terminals and the one or more other information processing devices.
(9)

The information processing device according to any one of (1) to (8), wherein
the content is a game content.
(10)

An information processing method executed by an information processing device communicably provided with a user terminal, the information processing method comprising:
executing a content for the user terminal;
acquiring an internal state of a content space from the user terminal;
extracting a target object included in a field of view of a user at present or in the near future on the basis of the internal state;
determining whether rendering the content space by a known object of the user terminal is possible on the basis of the target object;
selecting, in a case where it is determined that the rendering is possible, first rendering by the user terminal as a rendering method; and
selecting, in a case where it is determined that the rendering is not possible, second rendering by the information processing device as the rendering method.
(11)

A program for causing a computer communicably provided with a user terminal to execute processing including:
executing a content for the user terminal;
acquiring an internal state of a content space from the user terminal;
extracting a target object included in a field of view of a user at present or in the near future on the basis of the internal state;
determining whether rendering of the content space by a known object of the user terminal is possible on the basis of the target object;
selecting, in a case where it is determined that the rendering is possible, first rendering by the user terminal as a rendering method; and
selecting, in a case where it is determined that the rendering is not possible, second rendering by the information processing device as the rendering method.

### Reference Signs List

1 GAME SYSTEM
5 DATA CENTER
10, 10A GAME SERVER
11 STORAGE UNIT
111 GAME DATA STORAGE UNIT
111a GAME IMAGE
111b GAME OBJECT
12 COMMUNICATION UNIT
13 CONTROL UNIT
131 SECOND RENDERING UNIT
131a GAME COMMAND RECEPTION UNIT
131b GAME EXECUTION UNIT
131c RENDERING UNIT
131d STREAMING UNIT
132, 132A GAME LOGIC UNIT
132Aa MULTI-STATE SYNCHRONIZATION UNIT
132a GAME STATE SYNCHRONIZATION UNIT
132b GAME STATE UPDATE UNIT
133 METHOD SELECTION UNIT
133a GAME DATA ACQUISITION UNIT
133b DETERMINATION UNIT
30 GAME TERMINAL
31 STORAGE UNIT
311 GAME DATA STORAGE UNIT
311a GAME IMAGE
311b GAME OBJECT
32 COMMUNICATION UNIT
33 CONTROL UNIT
331 FIRST RENDERING UNIT
331a GAME STATE SYNCHRONIZATION UNIT
331b GAME EXECUTION UNIT
331c RENDERING UNIT
332 SECOND RENDERING UNIT
332a GAME COMMAND TRANSMISSION UNIT
332b STREAMING RECEPTION UNIT
333 METHOD SELECTION UNIT
333a GAME DATA DISCLOSURE UNIT
333b METHOD RECEPTION UNIT

1. An information processing device that is communicably provided with a user terminal and executes a content for the user terminal, the information processing device comprising
a control unit that
acquires an internal state of a content space from the user terminal,
extracts a target object included in a field of view of a user at present or in the near future on the basis of the internal state,
determines whether rendering of the content space by a known object of the user terminal is possible on the basis of the target object,
selects, in a case where it is determined that the rendering is possible, first rendering by the user terminal as a rendering method, and
selects, in a case where it is determined that the rendering is not possible, second rendering by the information processing device as the rendering method.

2. The information processing device according to claim 1, wherein
the control unit
executes the content that enables movement in the content space at least from a viewpoint of the user,
acquires a list of known objects of the user terminal from the user terminal,
selects the first rendering in a case where it is determined that all the target objects are known by the user terminal on the basis of the list, and
selects the second rendering in a case where it is determined that all the target objects are not known by the user terminal on the basis of the list.

3. The information processing device according to claim 2, wherein
the internal state
includes at least any one of a position of the user, an orientation of the user, a position of an object, and an orientation of an object in the content space, and
the control unit
estimates the target object included in the field of view of the user in the near future on the basis of the internal state.

4. The information processing device according to claim 2, wherein
the control unit
estimates the target object included the field of view of the user in the near future on the basis of a scenario of the content.

5. The information processing device according to claim 1, wherein
the control unit
acquires a command input by the user to the user terminal,
updates the internal state on the basis of the command, and
synchronizes the updated internal state with the user terminal.

6. The information processing device according to claim 5, wherein
the control unit
is simultaneously connectable to one or more of the user terminals,
updates the internal state of each of the user terminals on the basis of an input from each of the user terminals, and
synchronizes the updated internal state with each of the user terminals.

7. The information processing device according to claim 6, wherein
the control unit
is communicably provided with the user terminal, and is simultaneously connectable to one or more other information processing devices that execute the content for the user terminal,
updates the internal state of each of the other information processing devices on the basis of an input from each of the one or more other information processing devices, and
synchronizes the updated internal state with each of the other information processing devices.

8. The information processing device according to claim 7, wherein
the control unit
maintains sessions between one or more of the user terminals and the one or more other information processing devices.

9. The information processing device according to claim 1, wherein
the content is a game content.

10. An information processing method executed by an information processing device communicably provided with a user terminal, the information processing method comprising:
executing a content for the user terminal;
acquiring an internal state of a content space from the user terminal;
extracting a target object included in a field of view of a user at present or in the near future on the basis of the internal state;
determining whether rendering the content space by a known object of the user terminal is possible on the basis of the target object;
selecting, in a case where it is determined that the rendering is possible, first rendering by the user terminal as a rendering method; and
selecting, in a case where it is determined that the rendering is not possible, second rendering by the information processing device as the rendering method.
